(19) United States
(12) Patent Application Publication
(10) Pub. No.: US 2010/0293265 A1
(43) Pub. Date: Nov. 18, 2010

(54) IP MULTIMEDIA SUBSYSTEM REGISTRATION

(76) Inventors: Fredrik Lindholm, Alvsjo (SE); Ralf Keller, Wurselen (DE)

Correspondence Address: ERICSSON INC., 6300 LEGACY DRIVE, M/S EVR 1-C-11, PLANO, TX, 75024, US

(21) Appl. No.: 12/811,590

(22) PCT Filed: Jan. 8, 2009
(86) PCT No.: PCT/EP09/50157

§ 371 Date: Jul. 2, 2010

Related U.S. Application Data
(60) Provisional application No. 61/020,200, filed on Jan. 10, 2008.

(51) Int. Cl. G06F 15/173

(52) U.S. Cl. 709/223

(57) ABSTRACT

A method of ensuring that a currently reachable contact address is registered for a user terminal within an IP Multimedia Subsystem, the method comprising registering a first contact address for said terminal with the IP Multimedia Subsystem, subsequently determining on a network side that said terminal is no longer reachable via said first contact address, and as a consequence of such a determination, registering on the network side a second reachable contact address on behalf of the user terminal, with the IP Multimedia Subsystem.

### TECHNICAL FIELD

The invention relates to the field of communications networks, and in particular to the field of IP Multimedia Subsystem Centralized Services networks.

### BACKGROUND

The IP Multimedia Subsystem (IMS) is the technology defined by the Third Generation Partnership Project (3GPP) to provide IP Multimedia services over mobile communication networks. IP Multimedia services provide a dynamic combination of voice, video, messaging, data, etc. within the same session. As the number of basic applications, and the media which it is possible to combine, increases, so will the number of services offered to the end users, giving rise to a new generation of personalised, rich multimedia communication services. The IMS is defined in the 3GPP Specification 23.228.

The IMS makes use of the Session Initiation Protocol (SIP) to set up and control calls or sessions between user terminals (or user terminals and application servers). The Session Description Protocol (SDP), carried by SIP signalling, is used to describe and negotiate the media components of the session. Whilst SIP was created as a user-to-user protocol, IMS allows operators and service providers to control user access to services and to charge users accordingly.

FIG. 1 illustrates schematically how the IMS 3 fits into the mobile network architecture in the case of a GPRS/PS access network. As shown in FIG. 1, control of communications occurs at three layers (or planes). The lowest layer is the Connectivity Layer 1, also referred to as the bearer, or traffic, plane and through which signals are directed to/from user terminals accessing the network. The GPRS network includes various GPRS Support Nodes (GSNs) 2a, 2b. A gateway GPRS support node (GGSN) 2a acts as an interface between the GPRS backbone network and other networks (radio network and the IMS network). A Serving GPRS Support Node (SGSN) 2b keeps track of the location of an individual Mobile Terminal and performs security functions and access control. Access to the IMS 3 by IMS subscribers is performed through an IP-Connectivity Access Network (IP-CAN). In FIG. 1 the IP-CAN is a GPRS network including entities linking the user equipment to the IMS 3 via the connectivity layer 1.

The IMS 3 includes a core network 3a, which operates over the Control Layer 4 and the Connectivity Layer 1, and a Service Network 3b. The IMS core network 3a includes nodes that send/receive signals to/from the GPRS network via the GGSN 2a at the Connectivity Layer 1 and network nodes that include Call/Session Control Functions (CSCFs) 5. The CSCFs 5 include Serving CSCFs (S-CSCF) and Proxy CSCFs (P-CSCF), which operate as SIP proxies within the IMS in the middle, Control Layer.

At the top is the Application Layer 6, which includes the IMS service network 3b. Application Servers (ASs) 7 are provided for implementing IMS service functionality. Application Servers 7 provide services to end-users on a session-by-session basis, and may be connected as an end-point to a single user, or “linked in” to a session between two or more users. Certain Application Servers 7 will perform actions dependent upon subscriber identities (either the called or calling subscriber, whichever is “owned” by the network controlling the Application Server 7).

IMS relies on Internet Protocol (IP) as a transport technology. Using IP for voice communications, however, presents some challenges, especially in the mobile community where Voice Over IP (VoIP) enabled packet switched (PS) bearers may not always be available. To allow operators to start offering IMS-based services while voice enabled PS-bearers are being built out, the industry has developed solutions that use existing Circuit Switched (CS) networks to access IMS services. These solutions are referred to as IMS Centralized Services (ICS). ICS is also the name of the Work Item in 3GPP Release 8 addressing these matters.

Currently, ICS contains three alternative solutions known as I1-CS, I1-PS and “IMSC”. IMSC is a solution in which the network implements an adaptation function between a Global System for Mobile Communications (GSM) terminal and the IMS system. The terminal is not required to have any special functionality, but the CS network requires an update with new functionality in Mobile Switching Centres (MSC)/Visitor Location Registers (VLRs). The enhanced MSC server acts as the bridge between the CS network and the IMS network, providing the terminal with a point of presence in IMS. I1-CS and I1-PS both require ICS functionality in an accessing terminal. The CS network is on the other hand unaffected and transparent to the communication taking place between the ICS capable terminal and an IMS network. IMS CS Control Protocol (ICCP) is a control protocol standardized in 3GPP to allow an ICS capable terminal to communicate with service implementations in an IMS network when a CS network is used as a transport network. It is used for mid-call signalling for services such as call hold and call waiting. Unstructured Supplementary Services Data (USSD) carries the ICCP protocol transparently from an ICS terminal through the CS network to an “IMS-Adapter” that translates ICCP into SIP. The IMS-Adapter is a new functional entity in the IMS network, termed an IMS CS Control Function (ICCF).

A difference between I1-CS and I1-PS is that I1-PS uses SIP signalling over a PS access network for all ICS related signalling. This includes mid-call manipulations (for example hold/retrieve, Explicit Call Transfer), the addition of non-speech media to an existing call, IMS Registration, and so on. I1-CS, on the other hand, uses the CS (ICCP over USSD) access network for some purposes such as mid-call manipulations but not for other actions such as IMS Registration, the addition of media to calls, and multiparty calls.

FIG. 2 herein illustrates signalling principles for the I1-CS solution. A terminal 8 is shown that connects to an IMS network 3 via a PS access network 9 and a CS access network 10. Signalling from both access networks traverses an ICCF 11 in the IMS network 3. For both I1-CS and I1-PS, the PS access network 9 is either not suitable for, or not allowed to carry speech (shown as limited capability in FIG. 2), but suitable for SIP signalling. If the signalling takes place simultaneously with a CS voice call, Dual Transfer Mode (DTM) capabilities (the ability to have PS and CS bearers simultaneously in 2G (GSM/EDGE)) are required.

The two different signalling sessions shown in FIG. 2 relate to the same call and should be presented to a remote end (another terminal) as a single session. To be able to receive registered services, the network needs to be aware that the terminal is present. In IMS, the terminal will always register in order for the IMS network 3 to be able to know that the terminal is reachable. For I1-PS, the IMS registration takes place over the PS access network 9.

Similar for the IMSC scenario, the IMS network needs to be aware of the availability of the user to grant the user registered services. The current IMSC solution allows this by ensuring that the ICS enhanced visited MSC server acts as a terminal and registers in IMS on behalf of the CS terminal.

The main problems with current approaches are that for the I1-CS usage, the terminal cannot do an IMS registration. It has been proposed that the ICCF will always make an IMS registration on behalf of the terminal for the CS access. The problem with this is that it is not possible to have two registrations using the same private user identity at the same point in time. The PS registration is always needed when PS access is available. Hence, it is not possible to skip such registration. If a registration is not done for CS access, the problem that occurs is that, if I1-PS is used, and a fall back to I1-CS is needed, e.g., due to loss of PS coverage, the IMS network will treat the user as unregistered and only provide unregistered services for the user. If a full user experience is needed, then the IMS network needs to be configured to have the same services both for registered services and unregistered services. This will be a limitation to the system.

A similar problem occurs in the case of IMSC. If a user roams into a network or area where an ICS enhanced visited MSC server is not present, the user will not be registered in IMS by such an enhanced MSC. The home IMS network will not be able to detect that the user is registered in CS and can therefore not provide registered services to the user.

### SUMMARY

According to a first aspect of the invention, there is provided a method of ensuring that a currently reachable contact address is registered for a user terminal within an IP Multimedia Subsystem, the method comprising:
registering a first contact address for said terminal with the IP Multimedia Subsystem;
subsequently determining on a network side that said terminal is no longer reachable via said first contact address; and
as a consequence of such a determination, registering on the network side a second reachable contact address on behalf of the user terminal, with the IP Multimedia Subsystem.

The method may comprise determining whether or not said user terminal is associated with a user subscription allowing access to IP Multimedia Subsystem Centralized Services and performing said step of registering a second reachable contact address only if access is allowed.

Said first contact address may be an address associated with a packet switched access and said second contact address may be an address associated with a circuit switched access. Said step of subsequently determining that said terminal is no longer reachable via said first contact address may comprise determining that said packet access has been lost. The method may comprise, following registration of said second contact address, determining on a network side that said terminal is again reachable via said first contact address and, as a consequence, deregistering said second contact address. Registration of the first contact address may be initiated by the user terminal over the packet switched access.

Said steps of subsequently determining that said terminal is no longer reachable via said first contact address and registering a second reachable contact address may be performed within a circuit switched core network.

The method may comprise deregistering said first contact address with the IP Multimedia Subsystem in the event that it is determined that said terminal is no longer reachable via said first contact address.

The method may comprise, as a consequence of a determination on a network side that said terminal is no longer reachable via said first contact address, deregistering the first contact address with the IP Multimedia Subsystem.

Said first contact address may be associated with a Mobile Switching Centre of a circuit switched core network, the Mobile Switching Center providing a point of presence for the user terminal within the IP Multimedia Subsystem, and said second contact address may be associated with an alternative Session Initiation Protocol message destination.

Said step of registering a first contact address may be performed by said Mobile Switching Center.

Said alternative destination may be one of a Gateway Mobile Switching Centre, a Media Gateway Control Function, and a Session Initiation Protocol Application Server.

The method may comprise querying the IP Multimedia Subsystem to determine whether or not said first contact address is registered on behalf of the user terminal and, if not, performing said step of registering said second reachable contact address.

The method may comprise, following registration of said second contact address, querying the IP Multimedia Subsystem again to determine whether or not said first contact address has been reregistered and, if so, deregistering said second contact address.

The method may comprise, following registration of said second contact address, sending a notification from a Serving Control State Function to a registration function to inform the registration function when said first contact address has been reregistered, the registration function responding by deregistering said second contact address.

According to a second aspect of the invention, there is provided a method of ensuring that a currently reachable contact address is registered for a user terminal within an IP Multimedia Subsystem, where the user terminal may have available to it one or both of a packet switched and a circuit switched access, the method comprising:
when the user terminal has available to it both a packet switched and a circuit switched access, registering a first contact address associated with the packet switched access for said terminal with the IP Multimedia Subsystem;
subsequently determining on a network side that said terminal is no longer reachable via said packet switched access; and
as a consequence of such a determination, registering on the network side a second contact address associated with said circuit switched access on behalf of the user terminal, with the IP Multimedia Subsystem.

The step of registering a second contact address with the IP Multimedia Subsystem may be performed by a network based registration function.

According to a third aspect of the invention, there is provided a method of ensuring that a currently reachable contact address is registered for a user terminal within an IP Multimedia Subsystem, the method comprising:
where the user terminal is being served by an enhanced Mobile Switching Centre, registering a first contact address for said terminal with the IP Multimedia Subsystem, the first contact address being associated with said enhanced Mobile Switching Centre;
subsequently determining on a network side that said terminal is no longer reachable via said first contact address; and
as a consequence of such a determination, registering on the network side a second reachable contact address on behalf of the user terminal, with the IP Multimedia Subsystem, the second contact address being associated with an alternative Session Initiation Protocol message destination.

According to a fourth aspect of the invention, there is provided an apparatus configured to perform a network based registration function on behalf of user terminals, registering contact address for user terminals with an IP Multimedia Subsystem, and for use in implementing the method of any one of the first to third aspects of the invention.

According to a fifth aspect of the invention, there is provided a communications network node for ensuring that a currently reachable contact address is registered for a user terminal within an IP Multimedia subsystem, comprising: means for determining that said terminal is no longer reachable via a first contact address; and means responsive to such a determination for registering a second reachable contact address on behalf of the user terminal with the IP Multimedia Subsystem.

The node may comprise one of a Gateway Mobile Switching Centre, an Application Server, and a Media Gateway Control Function.

### BRIEF DESCRIPTION OF THE DRAWINGS

FIG. 1 is a schematic diagram illustrating a mobile network architecture;

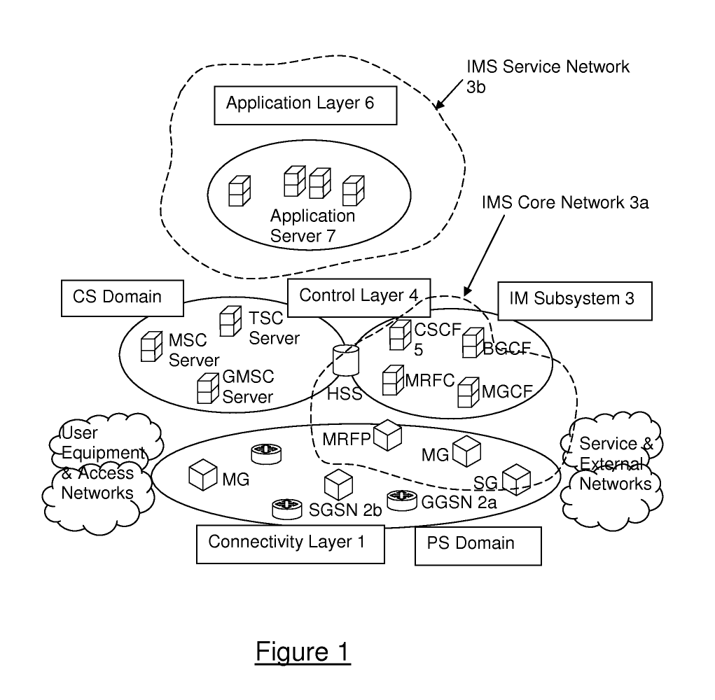

FIG. 2 is a diagram illustrating the signalling principles for a known I1-CS solution;

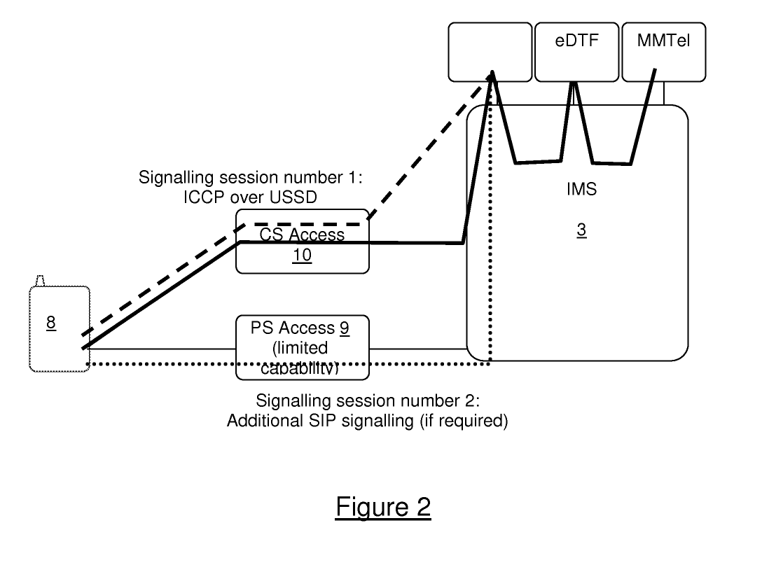

FIG. 3 is a flow diagram illustrating a network-based registration function constituting a first embodiment of the invention;

FIG. 4 is a flow diagram illustrating a network-based registration function constituting a second embodiment of the invention; and

FIG. 5 is a block schematic diagram of a network node constituting an embodiment of the invention.

### DETAILED DESCRIPTION

The following description sets forth specific details, such as particular embodiments, procedures, techniques, etc. for purposes of explanation and not limitation. In some instances, detailed descriptions of well known methods, interfaces, circuits, and devices are omitted so as not obscure the description with unnecessary detail. Moreover, individual blocks are shown in some of the drawings. It will be appreciated that the functions of those blocks may be implemented using individual hardware circuits, using software programs and data, in conjunction with a suitably programmed digital microprocessor or general purpose computer, using application specific integrated circuitry, and/or using one or more digital signal processors.

A high-level embodiment of the invention introduces a network based registration function that registers on behalf of the terminal through the CS access in the IMS network when really needed. This avoids the problem that the terminal will never be registered through CS access and also the problem of having multiple registrations for CS access and PS access which may interfere with each other. If the terminal is already registered in IMS through other means, e.g., through the PS access network, the network based registration function will not perform a registration of the terminal through CS access. If the terminal looses the IMS registration, but still is reachable through CS access, the network based registration function registers on behalf of the terminal.

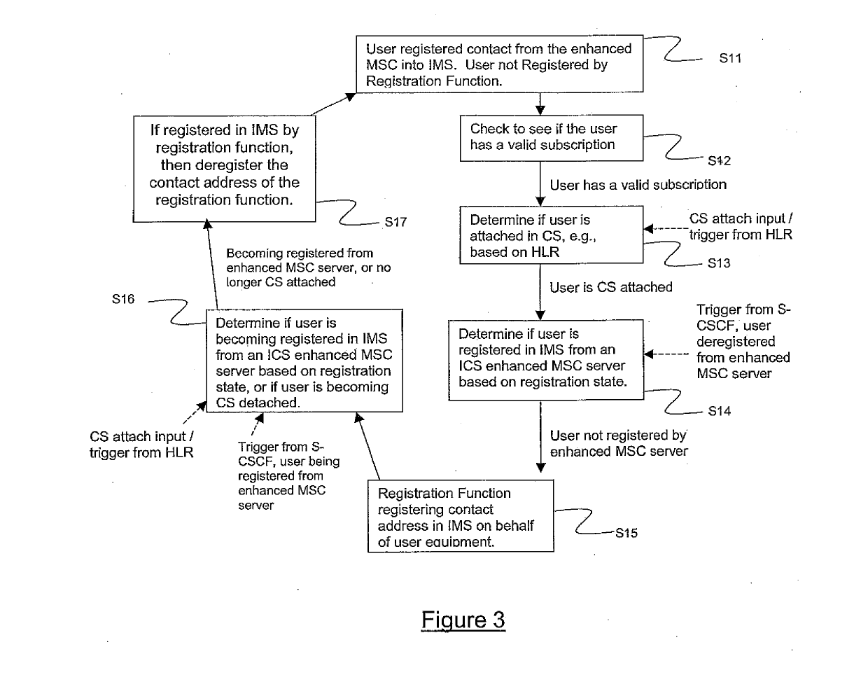

FIG. 3 is a diagram illustrating the detailed logic of the network based registration function when the IMSC scenario is used. In Step S11, the terminal is not registered in IMS via the CS access by the network based registration function. At this point in time, the terminal may however be registered in IMS by the ICS enhanced visited MSC server. The registration function must evaluate whether it needs to register the user or not.

In Step S12, the subscriber data is checked to validate if the user can use the IMS centralized services. This check may, for example, compromise validating that the related user has a set of identities provisioned related to ICS. If not, no further processing is needed and the network based registration function will not register on behalf of the terminal. This step can be seen as optional in case it is by other means already known that the user is allowed to use IMS centralized services. If Step S12 succeeds and the user is allowed to use ICS services, it proceeds to Step S13.

In Step S13, the network based registration function verifies that the terminal is CS access attached. This can be done e.g., by contacting the Home Location Register (HLR). If the user is CS attached, it proceeds to Step S14.

In Step S14, the network based registration function verifies if the terminal is already registered in IMS through an ICS enhanced visited MSC server. This can be done in different ways. In one embodiment of the invention, this is done by collocating the network based registration function with the Gateway MSC server. If the visited MSC server is not ICS capable, the network based registration function by default assumes that the terminal is not registered through an ICS enhanced visited MSC server. In another embodiment of the invention where the network based registration function is using the registration state in the IMS network, e.g., from the S-CSCF, the network based registration function can detect if the terminal has already been registered in IMS or not. It may even be possible to identify whether the registration has been performed by an ICS capable MSC server or by the UE provided that suitable information is included in the contact. If it is registered in IMS but not from the network based registration function, it can assume that it is registered from an ICS enhanced visited MSC server. This invention does not preclude other collocation options. If not registered in IMS from an ICS enhanced visited MSC server, Step S15 is performed.

In step S15, the network based registration function registers the terminal in IMS. When registering the terminal, the network based registration function will provide a contact address. As the terminal is not reachable through PS, it will not have a contact address. Instead, the network based registration function needs to insert a contact address to the entity where SIP messages should be sent. This could be a Gateway MSC, MGCF, and Application Server, or the address of the network element where the network based registration function resides.

In Step S16, the terminal is registered in IMS through the CS access via the network based registration function. At this point in time, the network based registration function needs to evaluate if the terminal needs to be deregistered for any reason. The terminal should become deregistered if either the terminal is no longer attached to CS (based on trigger input from HLR) or if the terminal becomes registered from an ICS enhanced visited MSC server (based on e.g., registration status information from the Serving-CSCF).

In Step S17, the network based registration function will ensure that the contact address registered by the network based registration function is deregistered. Hence, if it is still registered, it will deregister the contact information.

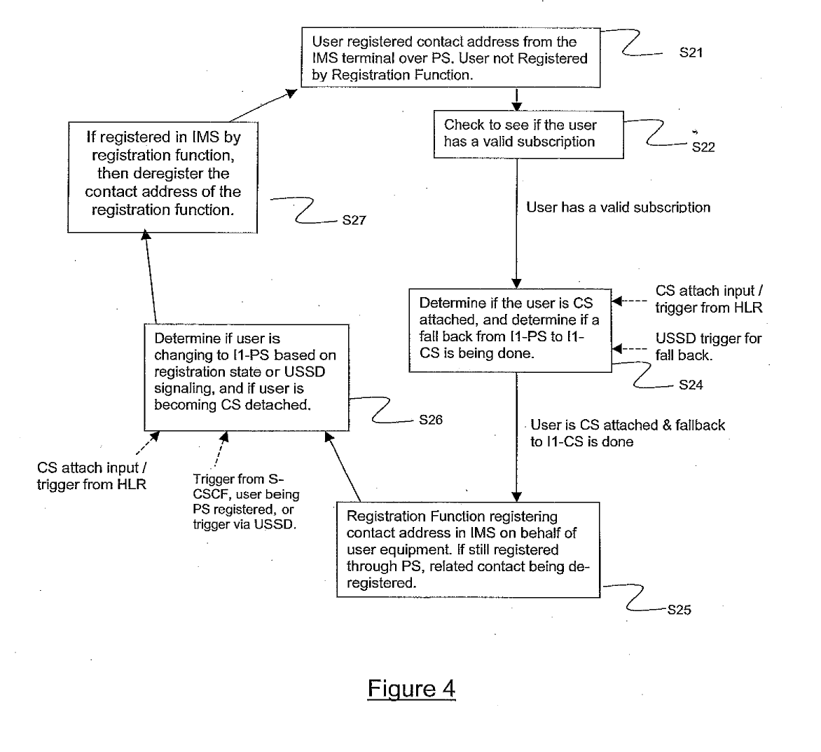

FIG. 4 is a diagram illustrating the detailed logic of the network based registration function when the I1-PS and I1-CS scenario is used. In Step S21, the terminal is not registered in IMS via the CS access by the network based registration function. At this point in time, the terminal may however be registered in IMS over the PS access using I1-PS. The registration function must evaluate whether it needs to register the user or not.

In Step S22, the subscriber data is checked to validate if the user can use the IMS centralized services. This check may, for example, compromise validating that the related user has a set of identities provisioned related to ICS. If not, no further processing is needed and the network based registration function will not register on behalf of the terminal. This step can be seen as optional in case it is already known by other means that the user is allowed to use IMS centralized services. If Step S22 succeeds and the user is allowed to use ICS services, it proceeds to Step S24.

Step S24 will occur when a fall back from I1-PS to I1-CS is done and the terminal is still CS attached. This means that the PS access is lost and the control signalling must be sent over CS instead. When this is done, this is used as a trigger to the network based registration function to register the terminal. Note that at this point in time, the terminal may still be registered over the PS access, even though it has lost the connectivity and is switching to CS access only. Step S25 is performed.

In step S25 the network based registration function registers the terminal in IMS. When registering the terminal, the network based registration function will provide a contact address. As the terminal is not reachable through PS, it will not have a contact address. Instead, the network based registration function needs to insert a contact address to the entity where SIP messages should be sent. This could be a Gateway MSC, MGCF, and Application Server, or the address of the network element where the network based registration function resides. When performing the registration from the network based registration function, any remaining registration through the PS access will be automatically de-registered.

In Step S26, the terminal is registered in IMS through the CS access via the network based registration function. At this point in time, the network based registration function needs to evaluate if the terminal needs to be deregistered for any reason.

Step S26 is performed to decide when the network based registration function should go back into a de-registered state. The network based registration function needs to monitor to see when a handover is done from I1-CS to I1-PS. This can be done e.g., by monitoring the USSD signalling or receiving registration state from the IMS network such as the S-CSCF. It also needs to determine if the terminal is still available over CS access (e.g., based on the HLR state). If the user is changing to I1-PS and is still CS attached, it continues to Step S27.

In Step S27, the network based registration function will ensure that the user is not registered by the network based registration function anymore. Hence, if it is still registered, it will deregister the terminal. An explicit de-registration will not always be necessary when changing from I1-CS to I1-PS as the CS registration will automatically be deregistered when the terminal registers over the PS access, as only one registration is allowed at a point in time using the same private user identity. In case different private user identities are being used for registration from CS and PS, there may be a need to do an explicit deregistration.

The logic for the network based registration function for the IMSC and for the I1-PS/I1-CS scenarios can also be combined.

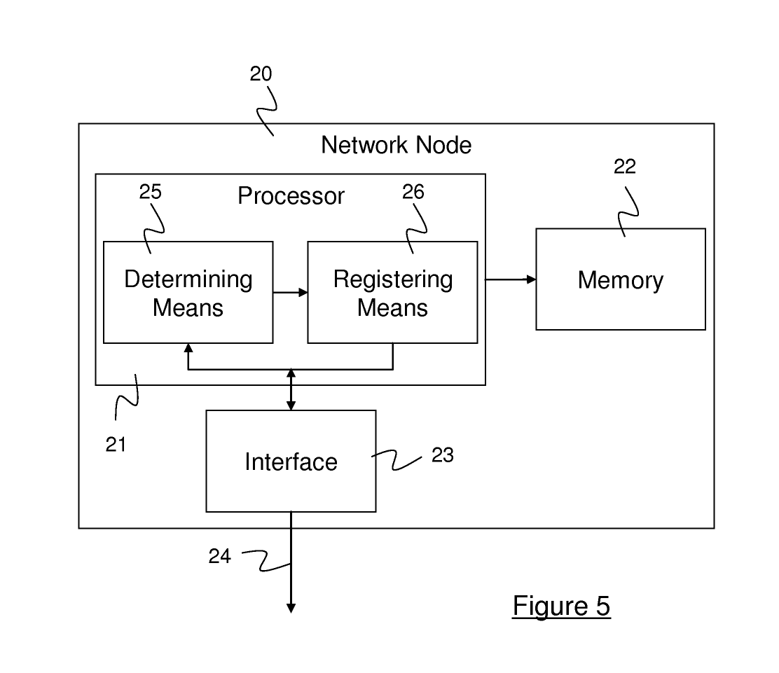

FIG. 5 illustrates a network node 20 for performing at least some of the functionality described hereinbefore. The network node 20 may, for example, comprise a Gateway Mobile Switching Centre (MSC), an Application Server, a Media Gateway Control Function (MGCF) or any other suitable node of the communications network for performing the functions.

The network node 20 is embodied, in this example, as a processor 21, such as a microprocessor, associated with a memory 22 containing a program for controlling the processor 21 and providing temporary and permanent memory for data produced by the processor 21. The processor 21 is connected via an interface 23 to an input/output port 24, which provides communication with the rest of the communications network.

The processor 21 embodies determining means 25 and registering means 26. The means 25 and 26 are embodied as functions within the processor 25 in accordance with a program contained in the memory 22. Control and data flows are illustrated by arrow heads in the lines interconnecting the various means of the network node 20.

The determining means 25 determines whether a user terminal is reachable via a first contact address. When the determining means 25 determines that the user terminal is no longer reachable via this address, it signals the registering means 26. In response to this determination, the registering means 26 registers a second reachable contact address on behalf of the user terminal with the IP Multimedia Subsystem 3.

Embodiments of the invention can ensure that a user will always be registered in the IMS, which means that it can always receive registered services. Interaction problems between possible CS registration and PS registration can be avoided by ensuring that it will either be registered in CS or in PS, but never in both at the same time.

1. A method of ensuring that a currently reachable contact address is registered for a user terminal within an IP Multimedia Subsystem, the method comprising:
registering a first contact address for said terminal with the IP Multimedia Subsystem;
subsequently determining on a network side that said terminal is no longer reachable via said first contact address; and
as a consequence of such a determination, registering on the network side a second reachable contact address on behalf of the user terminal, with the IP Multimedia Subsystem.

2. A method according to claim 1 and comprising determining whether or not said user terminal is associated with a user subscription allowing access to IP Multimedia Subsystem Centralized Services and performing said step of registering a second reachable contact address only if access is allowed.

3. A method according to claim 1, wherein said first contact address is an address associated with a packet switched access and said second contact address is an address associated with a circuit switched access.

4. A method according to claim 3, wherein said step of subsequently determining that said terminal is no longer reachable via said first contact address comprises determining that said packet access has been lost.

5. A method according to claim 3 or 4 and comprising, following registration of said second contact address, determining on a network side that said terminal is again reachable via said first contact address and, as a consequence, deregistering said second contact address.

6. A method according to claim 5, wherein reregistration of the first contact address is initiated by the user terminal over the packet switched access.

7. A method according to claim 1, wherein said steps of subsequently determining that said terminal is no longer reachable via said first contact address and registering a second reachable contact address, are performed within a circuit switched core network.

8. A method according to claim 1 and comprising deregistering said first contact address with the IP Multimedia Subsystem in the event that it is determined that said terminal is no longer reachable via said first contact address.

9. A method according to claim 1 and comprising, as a consequence of a determination on a network side that said terminal is no longer reachable via said first contact address, deregistering the first contact address with the IP Multimedia Subsystem.

10. A method according to claim 1 or 2, wherein said first contact address is associated with a Mobile Switching Centre of a circuit switched core network, the Mobile Switching Center providing a point of presence for the user terminal within the IP Multimedia Subsystem, and said second contact address is associated with an alternative Session Initiation Protocol message destination.

11. A method according to claim 10, wherein said step of registering a first contact address is performed by said Mobile Switching Center.

12. A method according to claim 10, wherein said alternative destination is one of a Gateway Mobile Switching Centre, a Media Gateway Control Function, and a Session Initiation Protocol Application Server.

13. A method according to claim 10 and comprising querying the IP Multimedia Subsystem to determine whether or not said first contact address is registered on behalf of the user terminal and, if not, performing said step of registering said second reachable contact address.

14. A method according to claim 13 and comprising, following registration of said second contact address, querying the IP Multimedia Subsystem again to determine whether or not said first contact address has been reregistered and, if so, deregistering said second contact address.

15. A method according to claim 13 and comprising, following registration of said second contact address, sending a notification from a Serving Control State Function to a registration function to inform the registration function when said first contact address has been reregistered, the registration function responding by deregistering said second contact address.

16. A method of ensuring that a currently reachable contact address is registered for a user terminal within an IP Multimedia Subsystem, where the user terminal may have available to it one or both of a packet switched and a circuit switched access, the method comprising:
when the user terminal has available to it both a packet switched and a circuit switched access, registering a first contact address associated with the packet switched access for said terminal with the IP Multimedia Subsystem;
subsequently determining on a network side that said terminal is no longer reachable via said packet switched access; and
as a consequence of such a determination, registering on the network side a second contact address associated with said circuit switched access on behalf of the user terminal, with the IP Multimedia Subsystem.

17. A method according to claim 16, wherein the step of registering a second contact address with the IP Multimedia Subsystem is performed by a network based registration function.

18. A method of ensuring that a currently reachable contact address is registered for a user terminal within an IP Multimedia Subsystem, the method comprising:
where the user terminal is being served by an enhanced Mobile Switching Centre, registering a first contact address for said terminal with the IP Multimedia Subsystem, the first contact address being associated with said enhanced Mobile Switching Centre;
subsequently determining on a network side that said terminal is no longer reachable via said first contact address; and
as a consequence of such a determination, registering on the network side a second reachable contact address on behalf of the user terminal, with the IP Multimedia Subsystem, the second contact address being associated with an alternative Session Initiation Protocol message destination.

19. Apparatus configured to perform a network based registration function on behalf of user terminals, registering contact address for user terminals with an IP Multimedia Subsystem, and for use in implementing the method of any one of claim 1, 16, or 18.

20. A communications network node for ensuring that a currently reachable contact address is registered for a user terminal within an IP Multimedia Subsystem, comprising: means for determining that said terminal is no longer reachable via a first contact address: and means responsive to such a determination for registering a second reachable contact address on behalf of the user terminal with the IP Multimedia Subsystem.

21. A node as claimed in claim 20, comprising one of a Gateway Mobile Switching Centre, an Application Server, and a Media Gateway Control Function.
